(19) United States
(12) Patent Application Publication
(10) Pub. No.: US 2010/0192749 A1
(43) Pub. Date: Aug. 5, 2010

(54) Vibraphone

(75) Inventor: Brandon Sims, Clinton Township, MI (US)

Correspondence Address: FISH & RICHARDSON PC, P.O. BOX 1022, MINNEAPOLIS, MN, 55440-1022, US

(73) Assignee: Conn-Selmer, Inc., Elkhart, IN (US)

(21) Appl. No.: 12/364,188

(22) Filed: Feb. 2, 2009

(51) Int. Cl. G10D 13/08

(52) U.S. Cl. 84/410

(57) ABSTRACT

A vibraphone includes a frame having first and second ends, and first and second rows of bars disposed on the frame. The vibraphone includes a damper disposed on the frame and configured to move between a first position away from the bars and a second position in contact with multiple bars. The damper engages the bars in the second position with a proportional contact area against each bar to provide substantially proportional dampening of each bar.

### TECHNICAL FIELD

This disclosure relates to vibraphones.

### BACKGROUND

The vibraphone, sometimes called the vibraharp, is a musical instrument generally in the mallet subfamily of the percussion family. It may be similar in appearance to the xylophone and marimba, although the vibraphone generally uses aluminum bars instead of wooden bars and the vibraphone generally has a sustain pedal that actuates a damper pad. Traditionally, vibraphones include damper pads configured as rectangular bars having piano felt disposed thereon.

### SUMMARY

The present disclose provides a vibraphone having a damper system configured to provide substantially proportional dampening to struck bars of the vibraphone. Traditional rectangular bar shaped damper pads generally provide non-proportional contact with the bars of the vibraphone. As a result, the bars of the vibraphone traditionally fail to receive proportional dampening across the instrument, allowing some bars to be dampened or silenced quicker than others. The vibraphone dampening system featured herein provides substantially uniform sound dampening, allowing stuck bars to be dampened at a substantially equal rate.

In one aspect, a vibraphone includes a frame having first and second ends, and first and second rows of bars disposed on the frame. The vibraphone includes a damper disposed on the frame and configured to move between a first position away from the bars and a second position in contact with multiple bars. The damper engages the bars in the second position with a proportional contact area against each bar to provide substantially proportional dampening of each bar.

Implementations of the disclosure may include one or more of the following features. In some implementations, the damper defines a substantially trapezoidal shape in top view, sized to provide a proportional contact area against each bar. The damper may define a substantially trapezoidal shape in top view having a first and second substantially parallel sides, the first side having a width of between about 35 mm and about 45 mm, the second side having a width of between about 90 mm and about 110 mm. In some examples, the damper includes a damper pad defining an arcuate top surface for providing variable engagement with the bars. The top surface of the damper pad may have a radius of curvature of between about 80 mm and about 130 mm.

In some implementations, the damper includes a damper pad for engaging the bars, and the damper pad comprises an elastic material. In some examples, the damper contacts between 8% and 12% of a bottom surface area each bar while in the second position.

In some implementations, the damper includes a base portion, a medial portion disposed on the base portion, and a damper pad disposed on the medial portion. The damper pad defines a substantially trapezoidal shape in top view, sized to provide a proportional contact area against each bar. The damper pad may define an arcuate top surface for providing variable engagement with the bars. The medial portion may define a substantially similar shape in top view as the damper pad for supporting the damper pad. In some examples, the vibraphone includes a damper mover configured to move the damper between the first and second positions.

The vibraphone may include a resonator disposed below each bar. A disc is rotatably coupled inside a top portion of each resonator, and a motor is coupled to each disc for moving the discs between a first, open position and a second, closed position. When the disks are open (e.g., standing vertically) the resonators have full function. When the disks are closed (e.g., lying horizontally) the vibrating column of air is blocked, reducing the amplification effect.

In another aspect, a damper for a vibraphone includes a damper body configured to engage bars of the vibraphone with a proportional contact area against each bar for substantially proportional dampening of each bar.

Implementations of the disclosure may include one or more of the following features. In some implementations, the damper body defines a substantially trapezoidal shape in top view, sized to provide a proportional contact area against each bar of the vibraphone. The damper body may define a substantially trapezoidal shape in top view having a first and second substantially parallel sides, the first side having a width of between about 35 mm and about 45 mm, the second side having a width of between about 90 mm and about 110 mm. In some examples, the damper body defines an arcuate top surface for providing variable engagement with the bars. The top surface of the damper body may have a radius of curvature of between about 80 mm and about 130 mm. In some implementations, the damper body includes a damper pad for engaging the bars, and the damper pad comprises an elastic material. The damper body may be configured to contact between 8% and 12% of a bottom surface area each engaged bar of the vibraphone.

In some implementations, the damper body includes a base portion, a medial portion disposed on the base portion, and a damper pad disposed on the medial portion. The damper pad defines a substantially trapezoidal shape in top view, sized to provide a proportional contact area against each bar of the vibraphone. The damper pad may define an arcuate top surface for providing variable engagement with the bars of the vibraphone.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a front perspective view of an exemplary vibraphone with resonators.

FIG. 1B is a rear perspective view of an exemplary vibraphone with resonators.

FIG. 2 is a top view of an exemplary vibraphone.

FIG. 3 is a section view of the vibraphone shown in FIG. 2, along line 3-3.

FIG. 4 is a bottom view of the vibraphone shown in FIG. 2.

FIG. 5 is a rear view of the vibraphone shown in FIG. 2.

FIG. 6 is a section view of the vibraphone shown in FIG. 5, along line 5-5.

FIG. 7 is a front view of an exemplary damper for a vibraphone.

FIG. 8 is a front view of the vibraphone shown in FIG. 2.

Like reference symbols in the various drawings indicate like elements.

### DETAILED DESCRIPTION

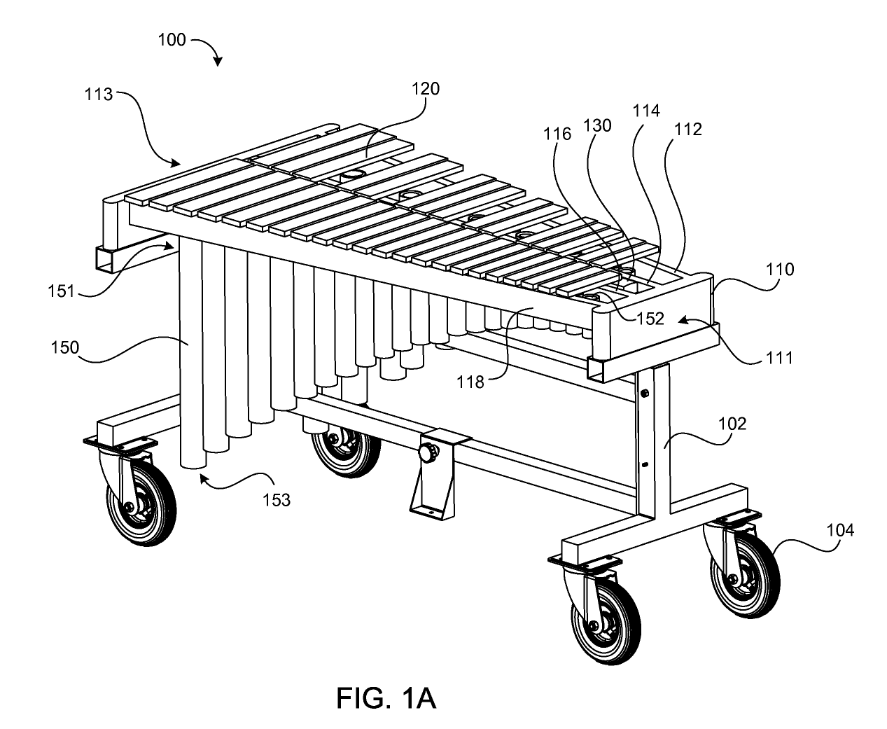

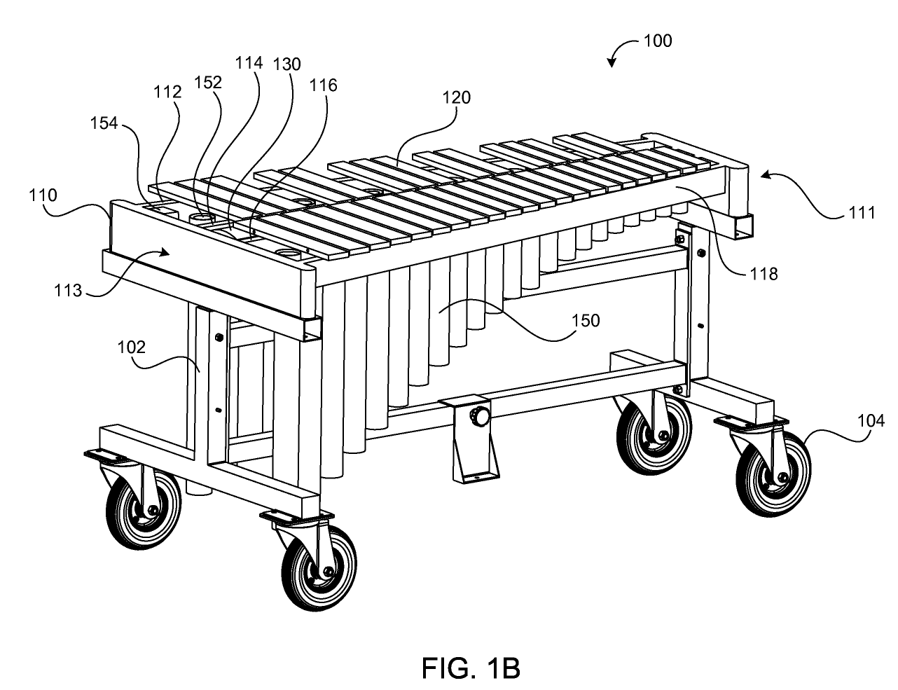

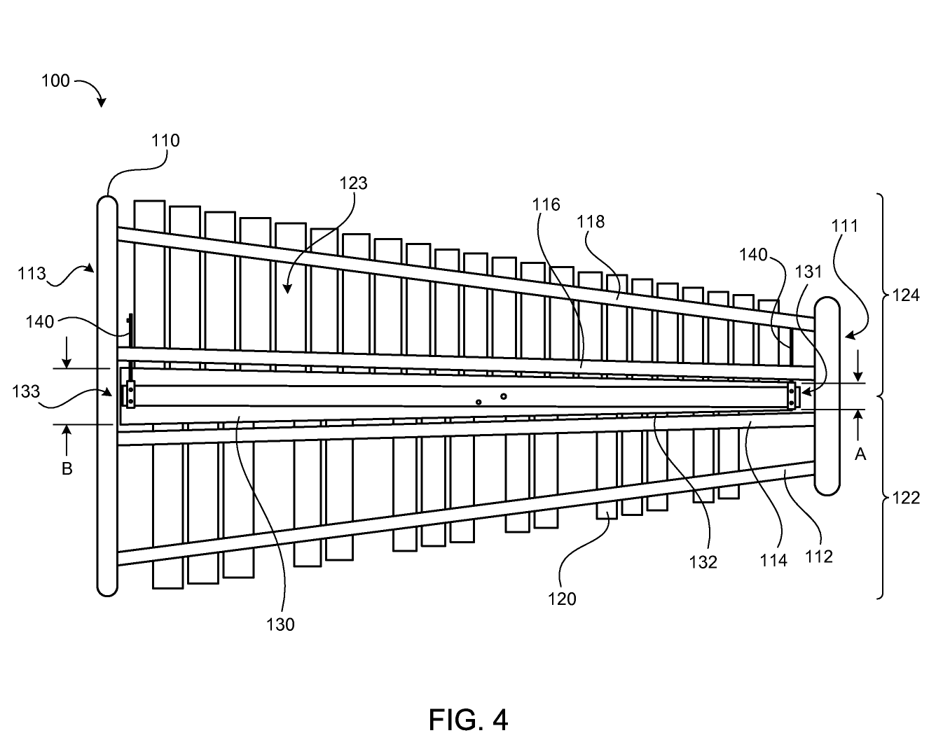

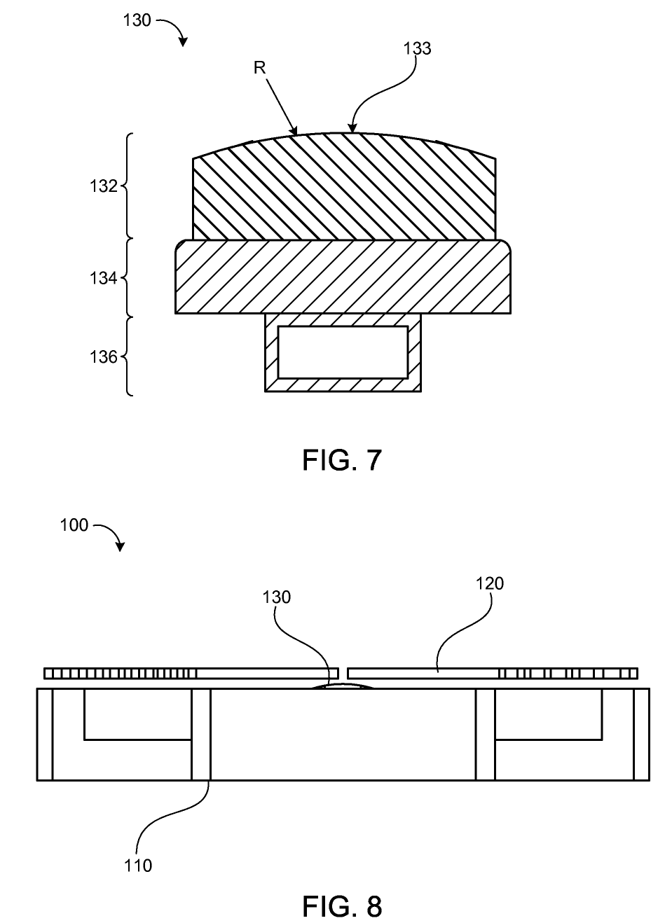

Referring to FIGS. 1A-8, a vibraphone 100 includes a frame 110 configured to support multiple bars 120, which are arranged in first and second rows 122, 124. In some implementations, the frame 110 includes first, second, third, and fourth supports 112, 114, 116, 118, where the first and second supports receive and support the first row 122 of bars 120 and the third and fourth supports receive and support the second row 124 of bars 120. Each row 122, 124 of bars 120 may be substantially a mirror image of the other and each bar 120 in each row 122, 124 may be sized incrementally larger than a previous bar 120 when progressing from a first end 111 of the frame 110 to a second end 113 of the frame 110, so as to provide different pitches or tones amongst each bar in that row 122, 124 when struck with a mallet during play. The vibraphone 100 defines a longitudinal axis 101, and the bar rows 122, 124 may be disposed on opposite sides of the longitudinal axis 101 from top view (FIG. 2). In some examples, the bars 120 are graduated (e.g., each bar 120 has an incrementally greater width W than the next bar 120, while progressing from the first frame end 111 to the second frame end 113). The vibraphone 100 may be supported on a cart or support frame 102, as shown in FIGS. 1A and 1B, which may include wheels 104 (e.g., caster wheels) for transporting the vibraphone 100.

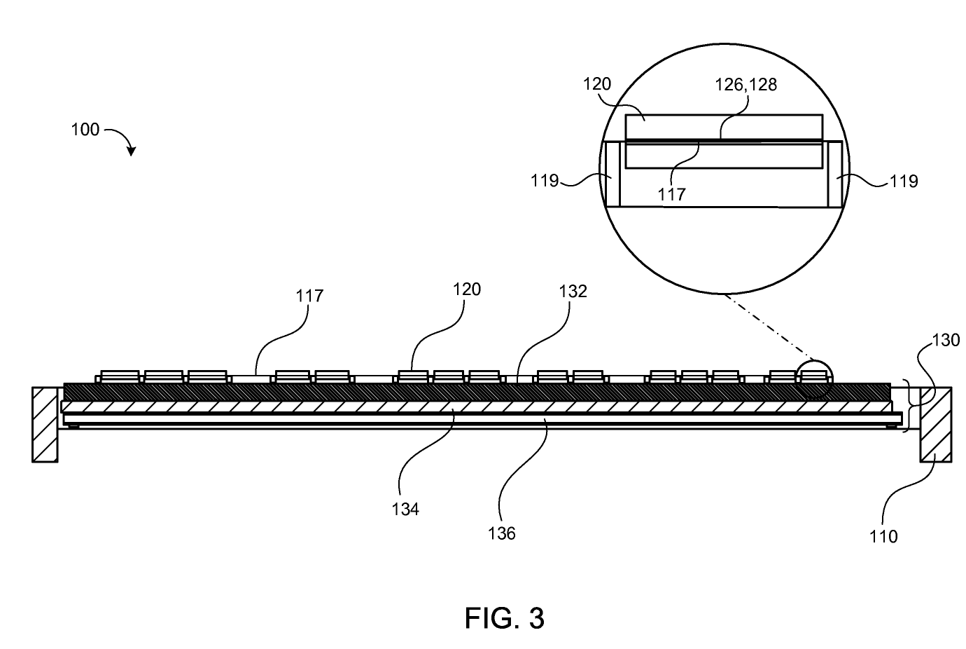

The vibraphone 100 includes a damper 130 disposed on the frame 110 and configured to dampen or quiet struck bars 120 while in contact with the bars 120. The damper 130 moves between a first position away from the bars 120 and a second position in contact with at least one bar 120, but preferably all of the bars. The damper 130 is actuated between the first and second positions by a damper mover 140. In some examples, the damper mover 140 is a two or four bar linkage disposed substantially near the first and second ends 111, 113 of the frame 110. The linkage may include links which have two or more joints that have various degrees of freedom to allow and translate motion between the links. The damper 130 is configured to provide substantially equal dampening for each bar 120 by contacting each bar 120 with a substantially proportional contact area 125. The contact area 125 of a relatively smaller bar (e.g., near the first end 111 of the frame 110) will have a proportionally smaller contact area 125 than that for a relatively larger bar (e.g., near the second end 113 of the frame 110). For example, the damper 130 may be configured to provide dampening to each bar by contacting between 8% and 12% of the bottom surface area 123 of each bar 120. By contacting a substantially equal percentage of the bottom surface area 123 of each bar 120, the damper 130 can provide substantially uniform sound dampening, allowing stuck bars to be dampened at a substantially equal rate. In some implementations, the damper 130 defines a trapezoidal shape from a top or bottom view as shown in FIGS. 2 and 4; however, other shapes may be suitable as well to provide the substantially proportional contact areas 125 amongst each of the bars 120. For example, the damper 130 may have scallop shaped (e.g., wavy) edges. In the example shown in FIG. 2, the damper 130 has a first width A at a first end 131 of the damper 130 of between about 35 mm and about 45 mm and a second width B at a second end 133 of the damper 130 of between about 90 mm and about 110 mm, with a substantially linear progression therebetween. The sides of the first and second ends 131, 133 may be substantially parallel.

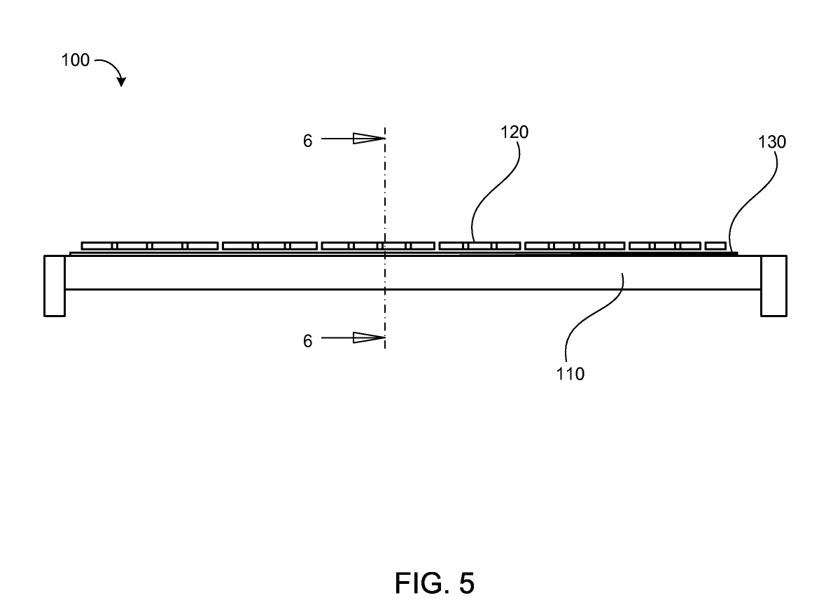

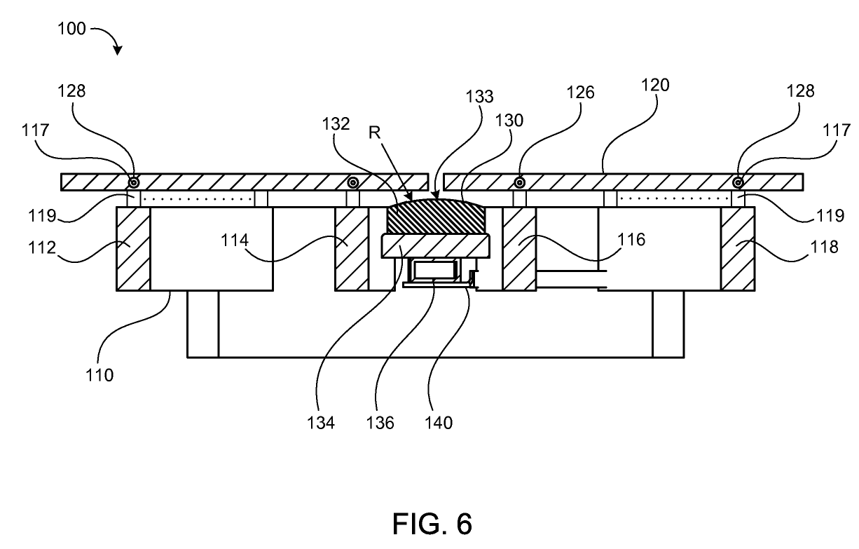

Referring to FIGS. 6 and 7, in some implementations, the damper 130 includes a damper pad 132 supported by a medial portion 134, which is further supported by a base portion 136. The damper pad 132 defines an arcuate top surface 133 that may have a radius of curvature R of between about 80 mm and about 130 mm. The arcuate top surface 133 allows partial engagement of the damper 130 against the bars 120. The contact area 125 of each bar 120 varies (e.g., is proportional) with the level of engagement of the damper 130 against the bars 120, from a minimal or nominal contact area 125 to a full contact area 125. In some examples, at least the portion of the damper pad 132 that includes the top surface 133, is compliant, so as to deform with engagement against the bars 120. In some examples, the top portion 133 of the damper pad 132 includes an elastic material, such as foam or rubber. In other examples, the entire damper pad 132 comprises an elastic material. The damper pad 132 defines a shape (e.g., trapezoidal from a top view) that provides proportional engagement of the bars 120 with the substantially proportional contact areas 125. The medial portion 134 may conform to the shape of the damper pad 132 (e.g., have the same shape from a top view). In some examples, the base portion 136 is a substantially rigid beam (e.g., metallic box beam) that supports the medial portion 134 and the damper pad 132. The base portion 136 may be configured to sustain the forces of movement and engagement of the damper 130 against the bars 120 without any substantial deflection. In some examples, the damper mover 140 is coupled to the base portion 136. A pedal (not shown) may be coupled to the damper mover 140 by a linkage for actuation of the damper mover 140. In other examples, a motor (not shown) is coupled to the damper mover 140 for actuating the damper mover 140 to move the damper 130 between its first and second positions.

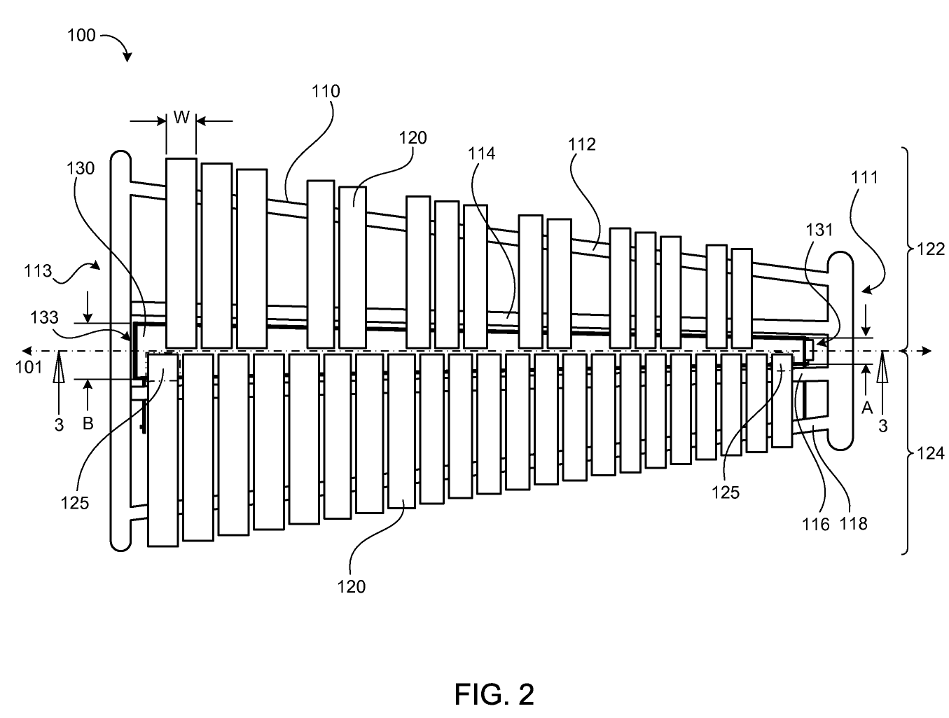

Referring again to FIGS. 3 and 6, in some implementations, the bars 120 comprise aluminum (e.g., 2024-T4 aluminum) and may be a composite or alloy to provide different tonal characteristics. First and second holes 126, 128 are defined by each bar 120 (e.g., along a transverse direction through a width of the bar 120) at “nodal” points. The nodal points are the points near the ends of the bar where the wave-like fundamental vibration of the sounding bar 120 causes little or no movement of the bar 120 itself (e.g., at a proportion of 0.244 from each end of the bar). Each hole 126, 128 is configured to receive a cord or string 117 (e.g., parachute cord) therethrough. The frame 110 includes pegs or fasteners 119 disposed on the first, second, third, and fourth supports 112, 114, 116, 118 and configured to receive and support the cords 117, which support the bars 120 through the holes 126, 128.

In some implementations, the vibraphone 100 includes a resonator 150 disposed below each bar 120, as shown in FIGS. 1A and 1B. The resonators 150 are thin-walled tubes (e.g., made of aluminum) that are open at a top end portion 151 and closed at the other, bottom end portion 153. The resonators 150 may be supported by the frame 110. Each bar 120 is paired with a resonator 150 having a diameter slightly wider than the width W of the bar 120 and a length to the closure of one-quarter of the wavelength of the fundamental frequency of the bar 120. When the bar 120 and resonator 150 are properly in tune with each other, the vibrating air beneath the bar 120, when struck (e.g., by a mallet), travels down the resonator 150 and reflects off the closure at the bottom of the resonator 150. The air returns back to the top the resonator 150 and is reflected back by the bar 120, over and over, creating a relatively stronger standing wave and amplifying the fundamental frequency of the vibraphone 100. The resonators 150, beside raising the upper end of the vibraphone's dynamic range, also affect the overall tone of the vibraphone 100, since they amplify the fundamental, but not the upper partials. In some implementations, each resonator 150 includes a disk 152 rotatably coupled inside a top end portion 151 of each resonator 150. The disks for a group of resonators 150 may be ganged together with a shaft (not shown) driven by an electric motor 154 to cause rotation of the disks 152 between open and closed positions. When the disks 152 are open (e.g., standing vertically) the resonators 150 have full function. When the disks 152 are closed (e.g., lying horizontally) the vibrating column of air is blocked, reducing the amplification effect.

A number of implementations have been described. Nevertheless, it will be understood that various modifications may be made without departing from the spirit and scope of the disclosure. Accordingly, other implementations are within the scope of the following claims.

What is claimed is:

1. A vibraphone comprising:
a frame having first and second ends;
first and second rows of bars disposed on the frame;
a damper disposed on the frame and configured to move between a first position away from the bars and a second position in contact with multiple bars;
wherein the damper engages the bars in the second position with a proportional contact area against each bar to provide substantially proportional dampening of each bar.

2. The vibraphone of claim 1, wherein the damper defines a substantially trapezoidal shape in top view, sized to provide a proportional contact area against each bar.

3. The vibraphone of claim 2, wherein the damper defines a substantially trapezoidal shape in top view having a first and second substantially parallel sides, the first side having a width of between about 35 mm and about 45 mm, the second side having a width of between about 90 mm and about 110 mm.

4. The vibraphone of claim 1, wherein the damper comprises a damper pad defining an arcuate top surface for providing variable engagement with the bars.

5. The vibraphone of claim 4, wherein the top surface of the damper pad has a radius of curvature of between about 80 mm and about 130 mm.

6. The vibraphone of claim 1, wherein the damper comprises a damper pad for engaging the bars, the damper pad comprising an elastic material.

7. The vibraphone of claim 1, wherein the damper contacts between 8% and 12% of a bottom surface area each bar while in the second position.

8. The vibraphone of claim 1, wherein the damper comprises:
a base portion;
a medial portion disposed on the base portion; and
a damper pad disposed on the medial portion;
wherein damper pad defines a substantially trapezoidal shape in top view, sized to provide a proportional contact area against each bar.

9. The vibraphone of claim 8, wherein the damper pad defines an arcuate top surface for providing variable engagement with the bars.

10. The vibraphone of claim 8, wherein the medial portion defines a substantially similar shape in top view as the damper pad for supporting the damper pad.

11. The vibraphone of claim 1, further comprising a damper mover configured to move the damper between the first and second positions.

12. The vibraphone of claim 1, further comprising:
a resonator disposed below each bar;
a disc rotatably coupled inside a top portion of each resonator; and
a motor coupled to each disc for moving the discs between a first, open position and a second, closed position.

13. A damper for a vibraphone, the damper comprising a damper body configured to engage bars of the vibraphone with a proportional contact area against each bar for substantially proportional dampening of each bar.

14. The damper of claim 13, wherein the damper body defines a substantially trapezoidal shape in top view, sized to provide a proportional contact area against each bar of the vibraphone.

15. The damper of claim 14, wherein the damper body defines a substantially trapezoidal shape in top view having a first and second substantially parallel sides, the first side having a width of between about 35 mm and about 45 mm, the second side having a width of between about 90 mm and about 110 mm.

16. The damper of claim 13, wherein the damper body defines an arcuate top surface for providing variable engagement with the bars.

17. The damper of claim 16, wherein the top surface of the damper body has a radius of curvature of between about 80 mm and about 130 mm.

18. The damper of claim 13, wherein the damper body comprises a damper pad for engaging the bars, the damper pad comprising an elastic material.

19. The damper of claim 13, wherein the damper body contacts between 8% and 12% of a bottom surface area each engaged bar of the vibraphone.

20. The damper of claim 13, wherein the damper body comprises:
a base portion;
a medial portion disposed on the base portion; and
a damper pad disposed on the medial portion;
wherein the damper pad defines a substantially trapezoidal shape in top view, sized to provide a proportional contact area against each bar of the vibraphone.

21. The damper of claim 20, wherein the damper pad defines an arcuate top surface for providing variable engagement with the bars of the vibraphone.
